(19) United States
(12) Patent Application Publication
(10) Pub. No.: US 2025/0225850 A1
(43) Pub. Date: Jul. 10, 2025

(54) Systems and Methods to Generate Deterrence Actions

(71) Applicant: Vivint, Inc., Provo, UT (US)

(72) Inventors: Logan Sanders Merkley, Provo, UT (US); Brandon Bunker, Provo, UT (US)

(73) Assignee: Vivint, Inc., Provo, UT (US)

(21) Appl. No.: 19/009,933

(22) Filed: Jan. 4, 2025

Related U.S. Application Data
(60) Provisional application No. 63/617,688, filed on Jan. 4, 2024.

(51) Int. Cl. G08B 13/196; G06V 10/774; G06V 20/52; G06V 40/10; G06V 40/20

(52) U.S. Cl. CPC G08B 13/19602; G06V 10/774; G06V 20/52; G06V 40/10; G06V 40/20

(57) ABSTRACT

A system may include a camera having one or more processors and a memory including instructions which, when executed by the one or more processors, cause the one or more processors to execute a first deterrence action, determine a response to the first deterrence action, receive a second deterrence action generated using a large language model, and execute the second deterrence action.

### CROSS REFERENCE

This application claims priority to U.S. Provisional Patent Application, 63/617,688, filed Jan. 4, 2024, and entitled SYSTEMS AND METHODS TO GENERATE DETERRENCE ACTIONS, which is incorporated by reference herein in its entirety.

### TECHNICAL FIELD

This application generally relates to generating deterrence actions, such as audible sounds.

### BACKGROUND

Home security systems may detect the presence of persons and execute an automatic deterrence action, such as playing a siren or a voice recording of a homeowner. However, such automatic deterrence actions may not be effective at deterring certain actions and may decrease in effectiveness over time as people grow accustomed to the automatic deterrence action.

### BRIEF DESCRIPTION OF THE DRAWINGS

The accompanying drawings constitute a part of this specification, illustrate an embodiment, and, together with the specification, explain the subject matter of the disclosure.

FIG. 1 illustrates an example environment 100 in which the present systems and methods may be implemented.

FIG. 2 is a flowchart of an example method for generating deterrence actions using a large language model (LLM).

FIG. 3 is a flowchart of an example method for training an LLM to generate deterrence actions.

FIG. 4 is a flowchart of an example method of deploying an LLM to generate deterrence actions.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

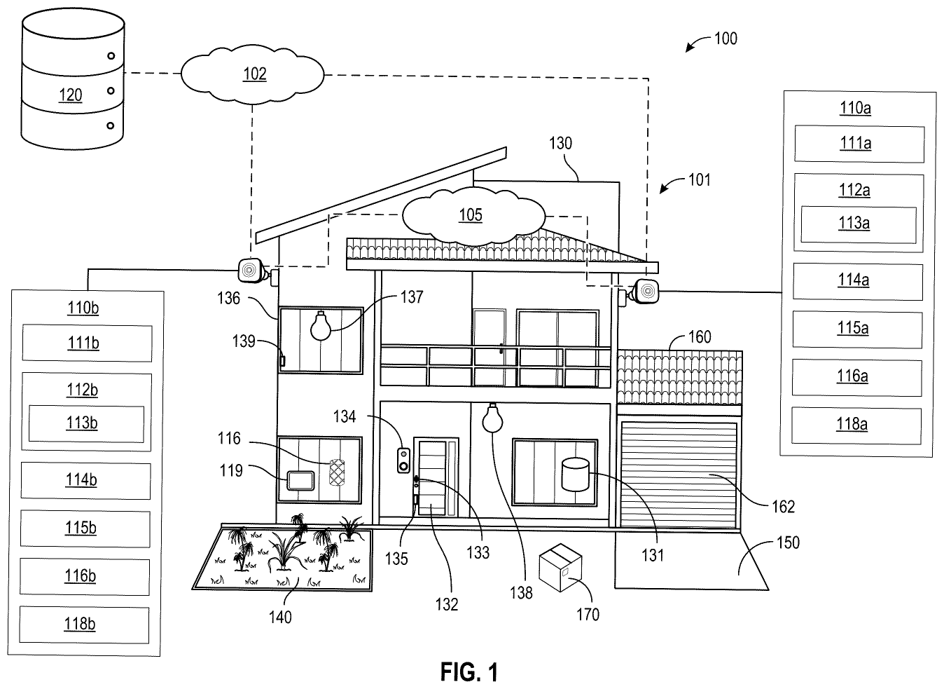

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

The building 130 may include a security system 101 or one or more security devices that are configured to detect and mitigate crime and property theft and damage by alerting a trespasser or intruder that their presence is known while optionally alerting a monitoring service about detecting a trespasser or intruder (e.g., burglar). The security system 101 may include a variety of hardware components and software modules or programs configured to monitor and protect the environment 100 and one or more buildings 130 located thereat. In an embodiment, the security system 101 may include one or more sensors (e.g., cameras, microphones, vibration sensors, pressure sensors, motion detectors, proximity sensors (e.g., door or window sensors), range sensors, etc.), lights, speakers, and optionally one or more controllers (e.g., hub) at the building 130 in which the security system 101 is installed. In an embodiment, the cameras, sensors, lights, speakers, and/or other devices may be smart by including one or more processors therewith to be able to process sensed information (e.g., images, sounds, motion, etc.) so that decisions may be made by the processor(s) as to whether the captured information is associated with a security risk or otherwise.

The sensor(s) of the security system 101 may be used to detect a presence of a trespasser or intruder of the environment (e.g., outside, inside, above, or below the environment) such that the sensor(s) may automatically send a communication to the controller(s). The communication may occur whether or not the security system 101 is armed, but if armed, the controller(s) may initiate a different action than if not armed. For example, if the security system 101 is not armed when an entity is detected, then the controller(s) may simply record that a detection of an entity occurred without sending a communication to a monitoring service or taking local action (e.g., outputting an alert or other alarm audio signal) and optionally notify a user via a mobile app or other communication method of the detection of the entity. If the security system 101 is armed when a detection of an entity is made, then the controller(s) may initiate a disarm countdown timer (e.g., 60 seconds) to enable a user to disarm the security system 101 via a controller, mobile app, or otherwise, and, in response to the security system 101 not being disarmed (or being accepted by a user prior to completion of the countdown timer), communicate a notification including detection information (e.g., image, sensor type, sensor location, etc.) to a monitoring service (optionally after giving a user a chance to disarm the security system 101), which may, in turn, notify public authorities, such as police, to dispatch a unit to the environment 100, initiate an alarm (e.g., output an audible signal) local to the environment 100, communicate a message to a user via a mobile app or other communication (e.g., text message), or otherwise.

In the event that the security system 101 is armed and detects a trespasser or intruder, then the security system 101 may be configured to generate and communicate a message to a monitoring service of the security system 101. The monitoring service may be a third-party monitoring service (i.e., a service that is not the provider of the security system 101). The message may include a number of parameters, such as location of the environment 100, type of sensor, location of the sensor, image(s) if received, and any other information received with the message. It should be understood that the message may utilize any communications protocol for communicating information from the security service to the monitoring service. The message and data contained therein may be used to populate a template on a user interface of the monitoring service such that an operator at the monitoring service may view the data to assess a situation. In an embodiment, a user of the security system 101 may be able to provide additional information that may also be populated on the user interface for an operator in determining whether to contact the authorities to initiate a dispatch. The monitoring service may utilize a standard procedure in response to receiving the message in communicating with a user of the security service and/or dispatching the authorities.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a depth sensor 114a (e.g., radar sensor 114a), a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same, but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect a breach of security event for which the respective sensors are configured. For example, the microphones 118 may be configured to sense sounds, such as voices, broken glass, door knocking, or otherwise, and an audio processing system may be configured to process the audio so as to determine whether the captured audio signals are indicative of a trespasser or potential intruder of the environment 100 or building 130. Each of the signals generated or captured by the different sensors may be processed so as to determine whether the sounds are indicative of a security risk or not, and the determination may be time and/or situation dependent. For example, responses to sounds made when the security system 101 is armed may be different to responses to sounds when the security system 101 is unarmed.

A user interface 119 may be installed or otherwise located at the building 130. The user interface 119 may be part of or executed by a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the security system 101 and/or security device may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 130. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human (e.g., an entity) is, has, intends to, and/or may otherwise perform one or more suspicious acts, is unknown/unrecognized, has entered a restricted area/zone such as the first region of interest 140 or the second region of interest 150, the security system 101 and/or security devices may may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 162, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the security system 101 and/or one or more security devices-may include one or more speakers 116 The speaker(s) 116 may be independent from other devices or integrated therein. For example, the camera(s) may include one or more speakers 116 (e.g. speakers 116a, 116b) that enable sound to be output therefrom. In an embodiment, a controller or other device may include a speaker from which sound (e.g., alarm sound, tones, verbal audio, and/or otherwise) may be output. The controller may be configured to cause audio sounds (e.g., verbal commands, dog barks, alarm sounds, etc.) to play and/or otherwise emit those audio from the speaker(s) 116 located at the building 130. In an embodiment, one or more sounds may be output in response to detecting the presence of a human within an area. For example, the controller may cause the speaker 116 may play one or more sounds selected to deter a detected person from an area around a building 130, environment 100, and/or object. The speaker 116, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The security system 101, one or more security devices, and/or the speakers 116, in some implementations, may be configured to store and/or has access to a library comprising a plurality of different sounds and/or a set of dynamically generated sounds so that the controller 106 may vary the different sounds over time, thereby not using the same sound too often. In some embodiments, varying and/or layering sounds allows a deter sound to be more realistic and/or less predictable.

One or more of the sounds may be selected to give a perception of human presence in the environment 100 or building 130, a perception of a human talking over an electronic speaker 116 in real-time, or the like which may be effective at preventing crime and/or property damage. For example, a library and/or other set of sounds may include audio recordings and/or dynamically generated sounds of one or more, male and/or female voices saying different phrases, such as for example, a female saying “hello?,” a female and male together saying “can we help you?,” a male with a gruff voice saying, “get off my property” and then a female saying “what's going on?,” a female with a country accent saying “hello there,” a dog barking, a teenager saying “don't you know you're on camera?,” and/or a man shouting “hey!” or “hey you!,” or the like.

In some implementations, the security system 101 and/or the one or more security devices may dynamically generate one or more sounds (e.g., using machine learning and/or other artificial intelligence, or the like) with one or more attributes that vary from a previously played sound. For example, the security system, one or more security devices, and/or the speaker 116 may generate sounds with different verbal tones, verbal emotions, verbal emphases, verbal pitches, verbal cadences, verbal accents, or the like so that the sounds are said in different ways, even if they include some or all of the same words. In some embodiments, the security system 101, one or more security devices, the speaker 116 and/or a remote computer 125 may train machine learning on reactions of previously detected humans in other areas to different sounds and/or sound combinations (e.g., improving sound selection and/or generation over time).

The security system 101, one or more security devices, and/or the speaker 116 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The security system 101 and/or the one or more security devices, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the security system 101 and/or the one or more security devices may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the security system 101 and/or the one or more security devices may play a primary sound layered and/or overlapping with one or more secondary, tertiary, and/or background sounds, varying the sounds and/or the combination from one or more previously played sounds and/or combinations, or the like.

The security system 101 and/or the one or more security devices, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The security system 101 and/or the one or more security devices, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the security system 101 and/or the one or more security devices may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the security system 101 and/or the one or more security devices may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101 and/or the one or more security devices are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

In some implementations, the server 120 includes a large language model (LLM) 122. The LLM 122 may be trained to generate deterrence actions based on input from the cameras 110, the user interface 119, the mobile device, the IoT devices, and/or other devices. The server 120 and/or the LLM 122 may generate prompts for the LLM 122 based on the received input. The LLM 122 may generate an output based on the input. The output of the LLM 122 may be a deterrence action, or information for executing a deterrence action. In an example, the LLM 122 may, based on an input of a man approaching a package on a porch, generate an output of “Hey, you're being recorded! Don't touch that package!” The cameras 110 may execute the deterrence action by playing “hey, you're being recorded! Don't touch that package!” over the speakers 116. In some implementations, the server 120 includes a text-to-speech model for generating audio files based on the outputs of the LLM 122. In some implementations, the cameras 110 include a text-to-speech model for generating audio files based on the outputs of the LLM 122. In an example, the cameras 110 include a text-to-speech model based on a voice of a homeowner such that the cameras can deliver deterrence actions using the homeowner's voice based on the outputs of the LLM 122.

In some implementations, the LLM 122 is separate from the server 120 and communicates with the server 120 and/or the cameras 110 using the network 102. In some implementations, the LLM 122 is a third-party LLM 122 to which the server 120 sends prompts. In some implementations, the LLM 122 is executed on an LLM server associated with the server 120. In some embodiments, the LLM 122 may be local to the cameras 110 and/or the smart home device 131, or otherwise deployed proximate the house 130.

The LLM 122 may be trained using data from the cameras 110 and/or data on the server 120. The LLM 122 may be trained to generate outputs specific to the house 130. In an example, the LLM 122 may be trained based on a style of speaking of an owner of the house 130 such that the LLM 122 can imitate the owner of the house 130. In this example, the cameras 110 may execute deterrence actions generated by the LLM 122 that appear to originate from the owner of the house 130. In some implementations, the LLM 122 can be trained or configured to generate deterrence actions according to various predetermined styles.

The LLM 122 may be trained using data from a plurality of cameras and houses. In an example, the cameras 110 may send data to the server 120 and a plurality of other cameras may send data to the server 120. The LLM 122 may be trained according to the data on the server 120 from the cameras 110 and the plurality of other cameras. In this way, the LLM 122 may be trained to generate deterrence actions in response to a wide variety of circumstances. In some implementations, the LLM 122 is trained using data from a plurality of cameras and/or houses and then re-trained or updated using data specific to the cameras 110 and/or the house 130. In this way, the LLM 122 has robust training and is customized for use with the cameras 110 and/or the house 130.

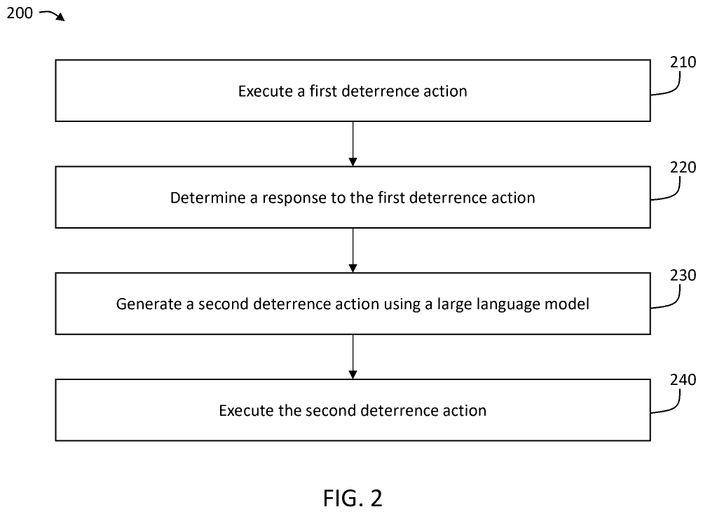

FIG. 2 is a flowchart of an example method 200 for generating deterrence actions using a large language model (LLM). The method 200 may be performed by one or more elements of the environment 100 of FIG. 1, such as the cameras 110 and the LLM 122. The method 200 may include more, fewer, or different operations than shown. The operations may be performed in the order shown, in a different order, or concurrently.

The method 200 may include executing 210 a first deterrence action. The first deterrence action may be executed in response to a person approaching a building, such as a house, and/or one or more characteristics of the person, as discussed herein. The method 200 may include detecting the person. In some implementations, detecting the person includes determining an identity of a person. The deterrence action may be executed 210 based on an identity of the person. In an example, detecting a resident of the house does not trigger the deterrence action, but detecting a stranger triggers the deterrence action. In some implementations, the first deterrence action is a default deterrence action. In an example, the first deterrence action is a whistle. In another example, the deterrence action is siren. In another example, the deterrence action is activating a light source.

The method 200 may include detecting one or more characteristics of the person to determine whether to execute the first deterrence action. The camera and/or LLM may determine whether to execute the first deterrence action based on movement of the person. In an example, the camera may identify common paths taken by persons approaching a house and determine whether a person is taking a non-standard path. In an example, the camera may determine a speed of the person and determine that the person is approaching at an unusual speed (creeping, running). The camera and/or LLM may determine whether to execute the first deterrence action based on one or more actions of the person before approaching the house. In an example, the camera may determine that the person looked both ways along a street before approaching the house. In an example, the camera may determine that the person approached a neighbor's house or car before approaching the house. The camera and/or LLM may determine whether to execute the first deterrence action based on one or more items worn by or carried by the person. In an example, the camera may determine that the person is wearing a face mask. In an example, the camera may determine that the person has an item associated with a crime such as a crowbar, a weapon, or a can of spray paint. The camera and/or LLM may determine whether to execute the first deterrence action based on detecting multiple people. In an example, the camera may determine that an unusual number of people are approaching the house (e.g., a large crowd).

The method 200 may include determining 220 a response to the first deterrence action. The response may include one or more actions of the person. In an example, the response may include the person stopping and retreating from the house. In an example, the response may include the person hesitating and continuing to approach the house. In an example, the response may include a vehicle moving away from the house. In an example, the response may include a vehicle remaining parked at the house.

The first deterrence action may be associated with an expected response. The first deterrence action may be executed 210 in order to achieve the expected response. In an example, the expected response to a siren may be for a person loitering near the house to move away from the house. In an example, the expected response to a whistle may be for a person attempting to break into the house to move away from the house. In some implementations, determining the response 220 to the first deterrence action includes determining whether the first deterrence action resulted in the expected response associated with the first deterrence action. In some implementations, the expected response is not associated with a specific deterrence action, but is an expected response to executing 210 a deterrence action in response to detecting the person. In an example, the expected response to executing 210 the first deterrence action (whatever it may be) in response to a person approaching the house may be for the person to move away from the house.

In some implementations, the response may indicate that a deterrence action is not needed. In an example, the response of “I′m locked out of the house. Please call Mom,” may indicate that a deterrence action is not needed. The camera and/or the LLM may determine that a deterrence action is not needed. The camera and/or the LLM may determine an action to be performed based on the response. In some implementations, the LLM may be used to conduct a conversation with the person to determine which action should be performed based on the response. In an example, the LLM may conduct a conversation with the person in order to determine the mental state of the person, to determine the identity of the person, and/or to determine whether the person is afraid, nervous, and/or lying. In some implementations, the LLM may use audio analytics to determine whether a person is afraid, nervous, and/or lying. In an example, the LLM may be used to conduct a conversation with a neighbor to determine to contact the homeowner.

The method 200 may include generating 230 a second deterrence action using a large language model (LLM). The LLM may receive as input one or more environmental characteristics (e.g., weather, time of day, time of year), modes of operation (e.g., deter theft, deter loitering, deter strangers, home unoccupied, vacation mode), user preferences (loitering thresholds, severity of response), geographic data (population density, local effectiveness of various deterrence actions, local crime statistics, recent crimes in local area), and homeowner characteristics (speaking style, tone of voice) to generate 230 the second deterrence action. In some implementations, a prompt engine may receive data as input and generate a prompt for the LLM. The prompt may be based on a prompt template into which are inserted the relevant data. The LLM may generate 230 the second deterrence action and/or a description of the second deterrence action. In an example, the LLM may generate a script for the second deterrence action which is converted into an audio file by a text-to-speech model. The second deterrence action may be a combination of one or more actions implemented by one or more devices. In an example, the LLM may generate a description of a combination of flashing lights and sounds for the second deterrence action. In an example, the LLM may generate commands for a camera to execute a combination of flashing lights and sounds for the second deterrence action. In an example, the LLM may generate an API call to another device for the second deterrence action.

User feedback may be used to refine the LLM and/or refine inputs for generating deterrence actions. In an example, a user may indicate approval or disapproval of the second deterrence action. In an example, a user may select the second deterrence action from a set of proposed deterrence actions. In an example, a user may provide a preferred deterrence action in response to the generated second deterrence action. In an example, a user may provide names or descriptors for specific people to improve generated deterrence actions. In some implementations, the LLM is re-trained using the user feedback. In an example, a user-specific LLM is re-trained based on the user feedback. In some implementations, the inputs to the LLM are adjusted based on the user feedback. In an example, the prompt engine generates prompts for an LLM shared by multiple users in order to generate prompts according to the user feedback.

In some implementations, generating 230 the second deterrence action may include generating 230, using the LLM, the second deterrence action based on one or more characteristics of the person. The LLM may receive as input the one or more characteristics of the person. In some implementations, a camera classifies and/or determines the one or more characteristics of the person and provides the one or more characteristics of the person to the LLM. In some implementations, the camera provides the one or more characteristics of the person to a prompt engine which generates a prompt for the LLM. The LLM may generate 230 the second deterrence action to include or be specific to the one or more characteristics of the person. In an example, the one or more characteristics may include a clothing item of the person, such as a blue shirt. In this example, the LLM may generate 230 the second deterrence action to reference the blue shirt, such as, “you in the blue shirt! Stop!” In some implementations, the one or more characteristic may include an identity of a person. The LLM may generate 230 the second deterrence action to reference the identity of the person or to be specific to the identity of the person. In an example, the LLM may generate 230 the second deterrence action to include the identity of the person such as “Steve, go away! I have a restraining order!” In an example, the LLM may generate 230 the second deterrence action to be specific to the identity of the person such as “Bob, I told you to stop letting your dog poop in my yard!” In this way, the generated second deterrence action may provide the impression that someone is watching the premises and speaking through a speaker to the person. These specific deterrence actions may be more effective than repeated, generic deterrence actions.

In some implementations, the one or more characteristics of the person may include a mental state of the person. In an example, the camera may determine whether the person is drunk, high, or under the influence of various substances and may provide that information as input to the LLM. The LLM may generate 230 the second deterrence action based on the mental state of the person. In an example, the LLM may generate 230 the second deterrence action to include very slow, clear speech so the person can understand. In an example, the LLM may generate 230 the second deterrence action to include flashing lights based on flashing lights being effective to deter persons in the same mental state as the mental state of the person.

In some implementations, generating 230 the second deterrence action may include generating 230, using the LLM, the second deterrence action based on one or more actions of the person. The LLM may receive as input the one or more actions of the person. In some implementations, a camera classifies and/or determines the one or more actions of the person and provides the one or more actions of the person to the LLM. In some implementations, the camera provides the one or more actions of the person to a prompt engine which generates a prompt for the LLM. The camera may determine that the one or more actions trigger a deterrence action. The LLM may generate 230 the second deterrence action to include or be specific to the one or more actions of the person. In an example, the one or more actions may include loitering, or remining on or near the premises beyond a threshold amount of time. In this example, the LLM may generate 230 the second deterrence action to reference the action of the person such as “you've been hanging around my front gate for fifteen minutes now. What are you doing?” or “I see you there sitting behind the bushes.” In some implementations, the LLM may generate 230 the second deterrence action to prevent expected actions of the person. The camera may determine the expected actions and provide the expected actions as input to the LLM. In an example, the LLM generates 230 the second deterrence action based on the expected action being a package theft to prevent the package theft such as “this package is currently being monitored” or “you are being recorded and any theft will be reported to the police.” The LLM may generate 230 the second deterrence action to include or be specific to an intent of the person. An intent may be inferred by an artificial intelligence model based on actions and/or characteristics of the person and the intent may be provided to the LLM. In an example, the intent may include theft, vandalism, trespassing, burglary, of the like. In this example, the LLM may generate 230 the second deterrence action to reference the intent of the person such as “If you touch my car, the police are on the way.”

In some implementations, generating 230 the second deterrence action may include generating 230, using the LLM, the second deterrence action based on the response to the first deterrence action. The LLM may receive the response to the first deterrence action as input. In some implementations, the LLM may generate 230 the second deterrence action to reference the response to the first deterrence action. In an example, the LLM may generate 230 the second deterrence action to reinforce an initial response to the first deterrence action such as “that's right, you should hesitate. I′m watching you.” In an example, the LLM may generate 230 the second deterrence action to indicate escalation such as “was that not enough? Get out of here!” In an example, the LLM may generate 230 the second deterrence action to reference the first deterrence action such as “hey buddy, the whistle means I caught you. Now get out of here before I call the cops.”

In some implementations, generating the second deterrence action includes determining whether an escalated deterrence action is required. In some implementations, the camera may determine whether an escalated deterrence action is needed. In some implementations, the LLM may determine whether an escalated deterrence action is needed. The camera and/or LLM may determine the escalated deterrence action such as calling the police, sharing an audiovisual feed with the police, contacting the homeowner, contacting a security monitoring agent, contacting a neighbor, transferring speaker control to the homeowner, and/or transferring speaker control to a security monitoring agent. In this way, the LLM may serve as a filter for the homeowner by determining which events and/or conversations require the homeowner's attention.

The method 200 may include executing 240 the second deterrence action. Execution 240 of the second deterrence action may depend upon the form of the output of the LLM. In an example, the LLM may generate 230 the second deterrence action to include audio, lights, or a combination of the two. Executing 240 the second deterrence action may include playing audio from a speaker, such as a speaker of a camera, emitting light or a pattern of light from a light source, and/or activating one or more additional devices, such as a smart speaker, smart light, or garage door. Executing 240 the second deterrence action may include translating the output of the LLM into commands for the camera, light source, and/or additional devices. Executing 240 the second deterrence action may include forwarding commands generated by the LLM to their intended recipients, such as the camera, light source, and/or additional devices.

In some implementations, the first deterrence action may be generated by the LLM, similar to the second deterrence action. In this way, the LLM may iteratively generate deterrence actions based on the characteristics of the person, the actions of the person, and their responses to the generated deterrence actions. The LLM may continue to generate deterrence actions until the expected response is achieved. In some implementations, the LLM may engage in conversation with the person if the responses to the deterrence actions include speech from the person.

Although various examples have been discussed for home security and deterring actions such as theft, loitering, and vandalism, the method 200 may apply to deterring other actions, such as an unaccompanied child walking towards a pool. The first deterrence action may be a warning for the child to stay away from the pool. If the child continues to approach the pool, the second deterrence action may be tailored to the identity of the child and/or user preferences for deter actions, such as threats of losing TV privileges. If the child continues to approach the pool and/or enters the pool, another deterrence action of playing an alarm may be executed. Additionally, the LLM may generate a description of what is happening to send to a user, such as the child's parent. The description may be sent as a notification to the user's mobile device and/or may be played on a speaker.

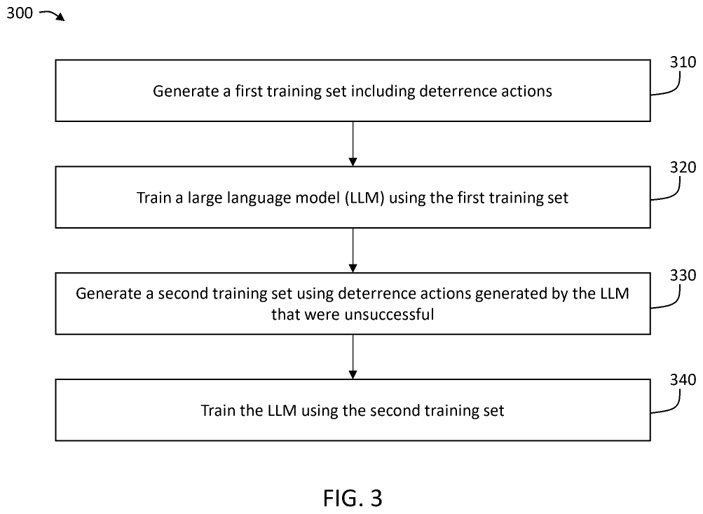

FIG. 3 is a flowchart of an example method 300 for training an LLM to generate deterrence actions. The method 300 may be performed by one or more elements of the environment 100 of FIG. 1, such as the cameras 110 and the LLM 122. The method 300 may include more, fewer, or different operations than shown. The operations may be performed in the order shown, in a different order, or concurrently.

The method 300 may include generating 310 a first training set including deterrence actions. The deterrence actions may include deterrence actions from a library of deterrence actions, deterrence actions generated by users, and/or deterrence actions generated by other artificial intelligence models, such as another LLM. In some implementations, the first training set includes text descriptions (e.g., instructions, commands, etc. and potentially according to a template form) of deterrence actions. In some implementations, the first training set may include videos of the deterrence actions being executed in response to detecting a person. In an example, the first training set includes videos captured by cameras of persons approaching homes and their responses to the deterrence actions. In some implementations, one or more of the videos of the deterrence actions being executed are artificially generated. In an example, the one or more videos are generated using generative AI from a description of the person, the person's actions, and/or the deterrence response. In some implementations, the descriptions used to generate the one or more videos are generated using another LLM. In this way, a large amount of training data may be generated without requiring user input.

The first training set may include labels indicating whether the deterrence actions were successful. The labels may be used in training the LLM in a supervised training process to indicate which deterrence actions were successful in which circumstances. In this way, the LLM may be trained to generate deterrence actions that are successful, based on training data indicating successful and unsuccessful deterrence actions. The first training set may also include other labels including time of day, geographic location, volume of the deterrence action, ambient noise volume, and other factors which may influence the effectiveness of the deterrence action. In this way, the LLM may be trained to generate effective deterrence actions based on time of day, geographic location, volume of the deterrence action, ambient noise volume, and other factors which may influence the effectiveness of the deterrence action.

The method 300 may include training 320 the LLM using the first training set. Training 320 the LLM using the first training set may include a supervised training process using labels, as described herein. Training 320 the LLM using the first training set may include an unsupervised training process, such as an adversarial training process where the LLM generates deterrence actions and a second artificial intelligence model determines whether the deterrence action would be effective and/or whether the deterrence action is human-generated or generated by the LLM. Training 320 the LLM using the first training set may include a combination of supervised and unsupervised training processes.

The method 300 may include generating 330 a second training set using deterrence actions generated by the LLM that were unsuccessful. The second training set may be generated in order to refine the LLM or to prevent overfitting of the LLM to the first training set. The second training set may be generated to correct errors made by the LLM. The second training set may include the deterrence actions generated by the LLM that were unsuccessful as well as alternative deterrence actions that would be successful and/or explanations as to why the generated deterrence actions were unsuccessful. The alternative deterrence actions may be provided by user feedback and/or another artificial intelligence model.

The method 300 may include identifying the deterrence actions generated by the LLM that were unsuccessful based on user input. In an example, a user may indicate that a generated deterrence action was unsuccessful. In an example, a user may provide a video of the unsuccessful deterrence action. The user input may include an alternative deterrence action. In an example, the user input may include text and/or speech which the user thinks would be more successful than the generated deterrence action. The user input may indicate a level of effectiveness of the generated deterrence action. In an example, the user input may indicate that the deterrence action was successful at causing a person to leave the premises, but that the speed of departure was slower than desired. The user input may include an indication of the expected or desired response. In an example, the user input may indicate that an expected or desired response to a deterrence action to deter a person from loitering is for the person to leave and not return, indicating that the generated deterrence action caused the person to leave, but only for a short time.

The method 300 may include identifying the deterrence actions generated by the LLM that were unsuccessful using an artificial intelligence model executed on a camera. The camera may execute the artificial intelligence model to determine whether a person performs an expected response in response to the generated deterrence action. In an example, the camera may determine a position of a person and determine whether the person leaves the premises in response to the generated deterrence action. In this example, if the expected response is for the person to leave the premises, the camera may determine whether the expected response was achieved by the deterrence action. In this example, the camera may determine that the deterrence action was unsuccessful based on the person not leaving the premises within a predetermined amount of time or before another deterrence action caused the person to leave the premises.

The method 300 may including training 340 or otherwise updating the LLM using the second training set. Training 340 the LLM using the second training set may include a supervised training process using labels, as described herein. Training 340 the LLM using the second training set may include an unsupervised training process, such as an adversarial training process where the LLM generates deterrence actions and a second artificial intelligence model determines whether the deterrence action would be effective and/or whether the deterrence action is human-generated or generated by the LLM. Training 340 the LLM using the second training set may include a combination of supervised and unsupervised training processes.

The method 300 may include generating additional training sets and training the LLM using the additional training sets. For example, the method 300 may include identifying a set of deterrence actions generated by the LLM after training using the second training set which were unsuccessful and using the set of unsuccessful deterrence actions to generate a third training set. The LLM may be iteratively trained until the LLM reaches a threshold accuracy or threshold effectiveness. The threshold effectiveness may be determined based on a proportion of generated deterrence actions which are successful. In some implementations, the LLM is continuously trained based on updated training data.

While the method 300 discusses training the LLM, the method 300 may be applied to training a prompt engine which generates prompts for the LLM based on input, as discussed herein. In this way, an existing and/or third-party LLM may be used by refining the prompts that are generated for the LLM.

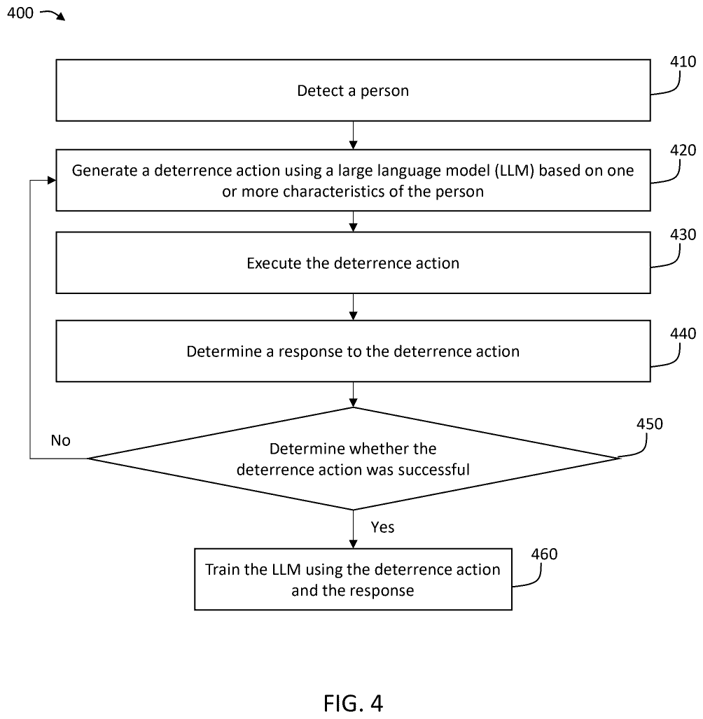

FIG. 4 is a flowchart of an example method 400 of deploying an LLM to generate deterrence actions. The method 400 may be performed by one or more elements of the environment 100 of FIG. 1, such as the cameras 110 and the LLM 122. The method 400 may include more, fewer, or different operations than shown. The operations may be performed in the order shown, in a different order, or concurrently.

The method 400 may include detecting 410 a person. The person may be detected by a camera executing an artificial intelligence model. The camera may detect one or more characteristics of the person. The characteristics of the person may include a clothing of the person, a height of the person, a mental state of the person, a gait of the person, a category of the person (e.g., delivery person, jogger, salesman, vagrant) and/or an identity of the person. The camera may determine one or more actions of the person including movement, predicted movement, interactions with one or more objects and/or predicted interactions with one or more objects.

The method 400 may include generating 420 a deterrence action using an LLM, based on one or more characteristics of the person. The LLM may generate the deterrence action based on the one or more characteristics of the person, the one or more actions of the person, and/or one or more circumstances (e.g., time of day, weather, geographic location), as discussed herein. The deterrence action may include sounds, speech, lights, and actions performed by one or more devices.

The method 400 may include executing 430 the deterrence action. In some implementations, the camera executes at least part of the deterrence action. In an example, the camera plays, using a speaker, a speech portion of the deterrence action.

The method 400 may include determining 440 a response to the deterrence action. The camera may, using the artificial intelligence model, determine one or more actions of the person in response to the deterrence action.

The method 400 may include determining 450 whether the deterrence action was successful. In some implementations, the camera may compare the response to the deterrence action with an expected response to determine whether the deterrence action was successful. In some implementations, a user may indicate whether the deterrence action was successful. If the deterrence action was not successful, the method 400 may repeat by generating 420 a new deterrence action using the LLM. The method 400 may iteratively generate deterrence actions and evaluate their success until an expected result is achieved.

If the deterrence action is successful, the method may progress to training 460 the LLM using the deterrence action and the response. In this way, the LLM may be continuously improved based successful deterrence actions. In some implementations, the LLM may be trained using successful deterrence actions generated by different LLMs and/or executed by different cameras.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
executing, by a camera, a first deterrence action;
determining, by the camera, a response to the first deterrence action;
generating, using a large language model (LLM), a second deterrence action; and
executing, by the camera, the second deterrence action.

2. The method of claim 1, wherein the first deterrence action is a default deterrence action.

3. The method of claim 1, further comprising detecting a person, wherein executing the first deterrence action is in response to detecting the person.

4. The method of claim 3, wherein generating, using the LLM, the second deterrence action includes generating, using the LLM, the second deterrence action based on one or more characteristics of the person.

5. The method of claim 3, wherein generating, using the LLM, the second deterrence action includes generating, using the LLM, the second deterrence action based on one or more actions of the person.

6. The method of claim 1, wherein determining the response to the first deterrence action includes determining whether the first deterrence action resulted in an expected response.

7. The method of claim 1, wherein generating, using the LLM, the second deterrence action includes generating, using the LLM, the second deterrence action based on the response to the first deterrence action.

8. A system comprising:
a camera including:
one or more processors; and
a memory including instructions which, when executed by the one or more processors, cause the one or more processors to:
execute a first deterrence action;
determine a response to the first deterrence action;
receive a second deterrence action generated using a large language model; and
execute the second deterrence action.

9. The system of claim 8, wherein the first deterrence action is a default deterrence action.

10. The system of claim 8, wherein the instructions further cause the one or more processors to detect a person, and wherein the one or more processors execute the first deterrence action in response to detecting the person.

11. The system of claim 10, wherein the second deterrence action is generated based on one or more characteristics of the person.

12. The system of claim 10, wherein the second deterrence action is generated based on one or more actions of the person.

13. The system of claim 8, wherein the instructions further cause the one or more processors to determine whether the first deterrence action resulted in an expected response.

14. The system of claim 8, wherein the second deterrence action is generated based on the response to the first deterrence action.

15. A method comprising:
generating a first training set including deterrence actions;
training a large language model (LLM) using the first training set;
generating a second training set using deterrence actions generated by the LLM that were unsuccessful; and
training the LLM using the second training set.

16. The method of claim 15, wherein the first training set includes labels indicating whether the deterrence actions were successful.

17. The method of claim 15, wherein the first training set includes videos of the deterrence actions being executed in response to detecting a person.

18. The method of claim 17, wherein one or more of the videos are artificially generated.

19. The method of claim 15, further comprising identifying the deterrence actions generated by the LLM that were unsuccessful based on user input.

20. The method of claim 15, further comprising identifying the deterrence actions generated by the LLM that were unsuccessful using an artificial intelligence model executed on a camera.

21. A system comprising:
one or more sensor devices, including a camera;
one or more output devices to implement deterrence actions;
one or more processors; and
a memory including instructions which, when executed by the one or more processors, cause the one or more processors to:
detect, using data captured by the one or more sensor devices, a person within an environment;
execute, by the one or more output devices, a first deterrence action directed to deterrence of the person;
determine a response of the person to the first deterrence action;
generate, using a large language model, a second deterrence action directed to greater deterrence of the person, wherein the second deterrence action is generated based on the response of the person to the first deterrence action; and
execute, by the one or more output devices, the second deterrence action.

22. The system of claim 21, wherein the first deterrence action is a default deterrence action.

23. The system of claim 21, wherein the instructions further cause the one or more processors to generate the first deterrence action according to the detection of the person.

24. The system of claim 21, wherein the second deterrence action is generated based on one or more characteristics of the person.

25. The system of claim 21, wherein the second deterrence action is generated based on one or more actions of the person.

26. The system of claim 21, wherein the instructions further cause the one or more processors to determine whether the first deterrence action resulted in an expected response by the person.

27. The system of claim 21, wherein the one or more output devices include the camera.

28. A system comprising:
one or more sensor devices, including a camera;
one or more output devices to provide deterrence actions;
one or more processors to:
detect, using data captured by the one or more sensor devices, a person within an environment;
determine, using the data captured by the one or more sensor devices, one or more characteristics of the person;
generate, using a large language model, and based on the one or more characteristics, a deterrence action directed to the person; and
execute, by the one or more output devices, the deterrence action.
